(19) United States
(12) Patent Application Publication
(10) Pub. No.: US 2020/0118194 A1
(43) Pub. Date: Apr. 16, 2020

(54) ORDER FULFILLMENT FROM SENSOR USAGE

(71) Applicant: International Business Machines Corporation, Armonk, NY (US)

(72) Inventors: Jeremy A. Greenberger, San Jose, CA (US); Lisa Seacat DeLuca, Baltimore, MD (US); Jeremy R. Fox, Georgetown, TX (US); Kelley Anders, East New Market, MD (US)

(21) Appl. No.: 16/158,547

(22) Filed: Oct. 12, 2018

(51) Int. Cl. G06Q 30/06; G06Q 10/06

(52) U.S. Cl. CPC G06Q 30/0635; G06Q 30/0641; G06Q 10/06311

(57) ABSTRACT

A method of order identification from sensors includes identifying an order placed by a customer that includes preparation of at least one item included in the order at a physical location, receiving the sensed order preparation information related to the order, generating a workflow that optimizes completion of a plurality of orders including the order by generating a set of modified tasks for employees and at least one automated order preparation device based at least in part on the received sensed order preparation information, and providing at least a portion of the set of modified tasks to the employees and to the at least one automated order preparation device.

### TECHNICAL FIELD

The present invention relates to fulfilling orders. More specifically, the invention relates to systems and methods for utilizing sensing technologies to improve order fulfillment.

### BACKGROUND

Today, many businesses meet consumer demand by allowing for multiple tasks to be completed asynchronously. For example, in a business such as a fast food restaurant or coffee shop, customers place orders and employees of the business must perform tasks in order to serve the customer. Asynchronous tasks allow the business to continue to take orders without waiting for the prior customer's order to be fulfilled. However, present systems are not fully optimized to fulfill tasks at the fastest possible rate and utilize employees with the maximum efficiency. Further, present systems do not provide sufficient updates with respect to when orders are completed, or likely to be completed. Thus, an improved system and method for completing tasks, fulfilling orders and/or notifying customers would be well received in the art.

### SUMMARY

An embodiment of the present invention relates to a method, and associated computer system and computer program product, for fulfilling orders. One or more processors of a computer system identify an order placed by a customer that includes preparation of at least one item included in the order at a physical location. The one or more processors receive sensed order preparation information from at least one sensor at the physical location, the sensed order preparation information related to the order. The one or more processors generate a workflow that optimizes completion of a plurality of orders including the order by generating a set of modified tasks for employees and at least one automated order preparation device based at least in part on the received sensed order preparation information. The one or more processors provide at least a portion of the set of modified tasks to the employees and to the at least one automated order preparation device.

### BRIEF DESCRIPTION OF THE DRAWINGS

FIG. 1 depicts a block diagram of a system for fulfilling orders, in accordance with embodiments of the present invention.

FIG. 2 depicts a perspective view of a physical location of the system of FIG. 1, in accordance with embodiments of the present invention.

FIG. 3A depicts a notification interface of the system for fulfilling orders of FIG. 1 at a first stage in a workflow, in accordance with embodiments of the present invention.

FIG. 3B depicts the notification interface of FIG. 3A at a second stage in the workflow, in accordance with embodiments of the present invention.

FIG. 4 depicts a flow chart of a method for fulfilling orders, in accordance with embodiments of the present invention.

FIG. 5 depicts a block diagram of a computer system for the system for fulfilling orders of FIGS. 1-2, capable of implementing methods such as the method for fulfilling orders of FIG. 4, in accordance with embodiments of the present invention.

FIG. 6 depicts a cloud computing environment, in accordance with embodiments of the present invention.

FIG. 7 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

The present invention improves and optimizes order fulfillment systems and methods. The present inventions recognizes that automated systems can reduce the amount of human interaction required to fulfill a given order. Embodiments of the present invention reduce and otherwise alter the tasks that are required to be performed via human interaction. Embodiments of the present invention operate, at least in part, independently of human interaction. Such a reduction leverages alternate methods of fulfilling tasks, which provides functionality to the computing system that did not previously exist. Further, embodiments of the present invention recognize that the manner in which tasks are performed by the system are not equivalent to the manner in which those same tasks would be performed via human interaction. As such, embodiments of the present invention recognize that humans have limited ability to be cognizant of changes in an environment, which may occur with a high customer volume, when those same humans are already busy performing tasks. A high customer volume may be determined, for example, based on a maximum number of orders that can be processed by a given location or venue. Embodiments of the present invention recognize that as a given venue approaches that maximum number of orders, the ability of employees to be cognizant of changes in that environment decreases. For example, in a scenario where a venue is at ninety percent of a maximum number of orders that can be processed by that venue, employees of that venue may be unable to adapt their tasks in response to changes in customer orders. In this example, the system identifies changes in the environment that are not recognized by the employees and provides a solution, including an updated workflow process, that alters the tasks being performed by the system such that the system adapts to changes in the environment and performs tasks using alternate methods those of the employees.

The present methods and systems allow for optimization of order fulfillment in a business, restaurant, café, store, home package or item delivery, or the like, particularly in situations of high customer volume. The present methods and systems further provide for detection of sub-optimal workflow processes through various sensing technology, along with the correction of such sub-optimal workflow processes. The present methods and systems improve order fulfillment by providing accurate and immediate information to customers so that product delivery becomes more efficient. The present invention further improves sensing systems by using sensors in new ways, and using the information received from sensors in new ways. The present methods further improve order fulfillment by automating order fulfillment, and devices for performing order fulfillment, based on automatically sensed information.

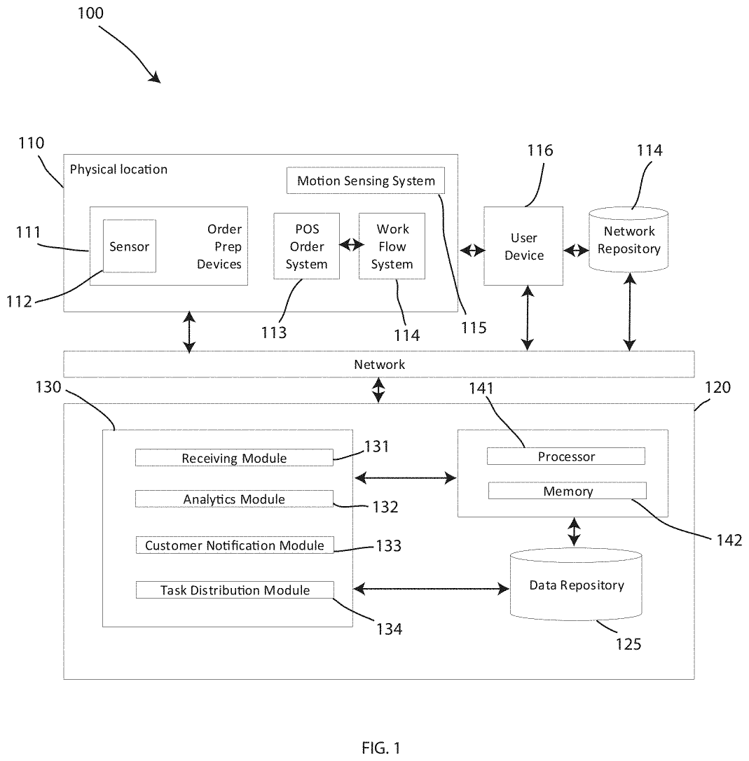

Referring to the drawings, FIG. 1 depicts a block diagram of a system for fulfilling orders 100, in accordance with embodiments of the present invention. Embodiments of a system for fulfilling orders 100 may include systems for sensing order related information, including order preparation information, movement information, and the like. The system for fulfilling orders 100 may further include systems for sensing sub-optimal workflow processes or systems for enhancing efficiency in order fulfillment. The system for fulfilling orders 100 may be a system for optimizing product delivery, in both a store or business, or with home delivery in commerce.

The system for fulfilling orders 100 may include a physical location 110 of a business. The physical location 110 may include at least one order preparation device 111 which may equipped with at least one order preparation sensor 112. The physical location 110 further includes a point of sale ordering system 113 in communication with a work flow system 114. The physical location 110 may further be equipped with a motion sensing system 115. The system for fulfilling orders 100 may include a user device 116 which may be owned and/or operated by a customer in the physical location, or a customer of the physical location that is not physically present in the event of a remote order placement. As shown, the sensors 112, 115 at the physical location 110 and/or the point of sale ordering system 113 and/or the work flow system 114 may be in communication with a computer system 120 over a network 107.

The physical location 110 may be a business, restaurant, café, home package delivery center, or the like. In one embodiment, the physical location 110 is a fast food restaurant. In another embodiment, the physical location is a coffee shop or café. The physical location may also be a warehouse or package distribution center. The physical location may be any enclosed or not enclosed structure that is configured to receive an order and/or at least partially fulfill the order.

The physical location 110 may include the point of sale order system 113. The point of sale order system 113 may be a cash register, a computer system, a mobile device, or the like. The point of sale order system 113 may be configured to receive an order input and/or accept payment for an order. For example, the point of sale order system 113 may be capable of accepting a credit card payment, or a payment directly from a user device such as a mobile phone using near field communication technology, or the like. The point of sale order system 113 may be connected directly to the computer system 120 and may provide information or data to the computer system 120 for processing.

The point of sale order system 113 may be in operable communication with the work flow system 114. In particular, the point of sale order system 113 may receive the order from a customer and may provide information related to the order to the work flow system 114. The work flow system 114 may include an interface configured to be received, reviewed, and/or otherwise used by an employee, operator, or the like. The work flow system 114 may assist the employee in fulfilling the order. The work flow system 114 may be connected to automated preparation devices that may also be utilized in fulfilling the order. The work flow system 114 may be configured to direct automated preparation devices in taking appropriate steps in fulfilling an order. The work flow system 114 may include displays or user interfaces for viewing an order and/or interacting with the work flow system 114 to, for example, update an order status or the like. The work flow system 114 may be connected directly to the computer system 120 and may provide information or data to the computer system 120 for processing.

The physical location 110 may further include at least one order preparation device 111. The order preparation device 111 may be an automated device, or a manual device requiring employee or user interaction. Non-limiting examples of order preparation devices contemplated herein include an oven, a fountain drink machine, a grill, a heater, a cooler, a refrigerator, a blender, a dishwasher, a coffeemaker, a griddle, a deep fryer, a microwave, or the like. Order preparation devices contemplated herein may further include the packaging of an ordered item. For example, the order preparation device may be a box, a cup, a wrapper or package. In the event of package distribution, the order preparation device 111 may be a truck or other vehicle, loading equipment, a conveyor, or the like. The order preparation device 111 may be any device used during the preparation or fulfillment of an order.

The order preparation device 111 may be provided with at least one sensor 112 attached or operably connected thereto. The sensor 112 may be a permanent sensor configured to sense a state of the order preparation device 111. For example, in the event that the order preparation device 111 is a food preparation device such as an oven, the sensor 112 of the order preparation device 111 may be configured to sense when the food preparation device begins a food preparation process and/or ends a food preparation process. The order preparation device 111 may be a deep fryer, and the sensor 112 may be configured to sense when an item has been placed within, or taken out of, the deep fryer. The order preparation device 111 may be a blender, and may be configured to sense when the blender is in process, being filled and/or having completed a process. The order preparation device 111 may be a coffee, tea or other beverage maker or coffee, tea or other beverage storage container, while the sensor 112 may be configured to sense when the coffee, tea or other beverage is being made, has been completed, or is being stored, along with the temperature of the coffee, or the like.

In the event that the order preparation device 111 is a vehicle, the sensor 112 may be configured to sense the location of the vehicle. The sensor 112 may be encompassed by a vehicle control system or computer system or the like. The sensor 112 may be a GPS sensor for determining the location of the vehicle. The sensor 112 may be configured to determine whether a vehicle is in route to a customer destination.

In the event that the order preparation device 111 is a disposable package, container or the like the sensor 112 may be a single user sensor. For example, in the event that the order preparation device 111 is a disposable cup, the sensor 112 may be a single-use sensor configured to detect when the cup has been filled with a liquid, for example, and provide confirmation of this event to the work flow system 114 and/or the computer system 120. The single-use sensor may located or embedded within the walls of a disposable cup, for example. Similarly, the sensor 112 may be located in a wrapper and may be configured to sense when the wrapper has been wrapped around a prepared item such as a burger. The sensor 112 may be located in a bowl, such as a soup bowl, and may be configured to sense when the soup bowl has been filled, or otherwise comes in contact with, soup. For example, a vertical strip of three single use sensors are attached to the wall of the container such that the system is able to sense (i) when the soup bowl has been filled and (ii) to what depth the bowl is filled. Various other embodiments are contemplated using single use sensors on disposable item packaging and/or containers.

The physical location 110 may further include a motion sensing system 115. The motion sensing system 115 may be configured to include one or more sensing devices placed or located within the physical location 110, in one embodiment, as described herein below. The one or more environment cameras may capture location information of where employees and customers are located in the physical location 110. Further, the one or more cameras may capture additional information such as image data or video data of user, including a posture, facial expressions, perspiration, muscle activity, gestures, etc. Embodiments of the motion sensing system 115 may also include one or more microphones positioned nearby the user to collect audio relating to the user, and other hardware input devices, such as an audio conversion device, digital camera or camcorder, voice recognition devices, graphics tablet, a webcam, VR equipment, mouse, touchpad, stylus, and the like, which may help provide data relating to an experience or movement of the user within the retail environment. The motion sensing system 115 may include an environmental sensor, a camera, a camcorder, a facial recognition sensor or the like positioned in one or more aisles of a retail venue, voice capture device, and the like. In one embodiment, a sensor or camera may be located in each aisle of the retail environment. In other embodiment, sensors or cameras may be disposed throughout the retail environment so movement and monitoring of each aisle may be tracked or sensed.

Still further, the motion sensing system 115 may be configured to sense the location of a customer or employee relative to a particular product, location, order preparation device, or the like, in the physical location 110. For example, the motion sensing system 115 may include RFID chips located in products, devices, furniture, or the like, configured to interact with the user device 116 and sense where the user is within the physical location 110. This may provide location information to the computer system 120 necessary to trigger the system providing notifications related to the status of an order, for example.

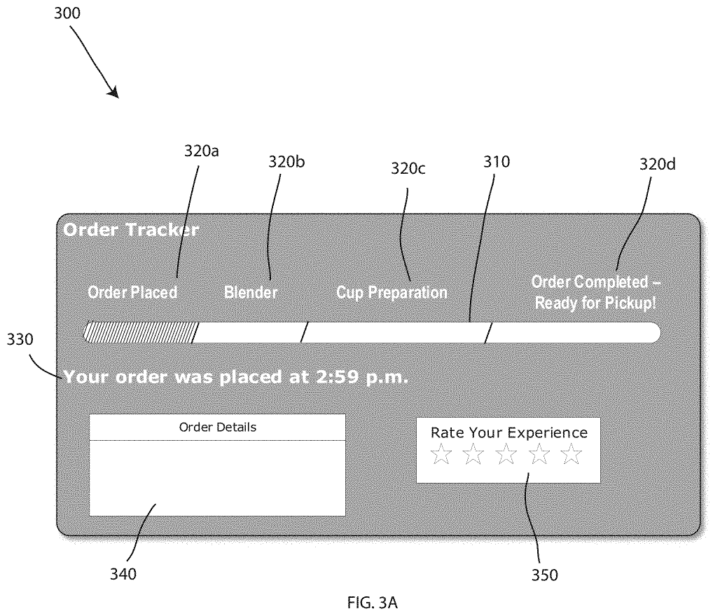

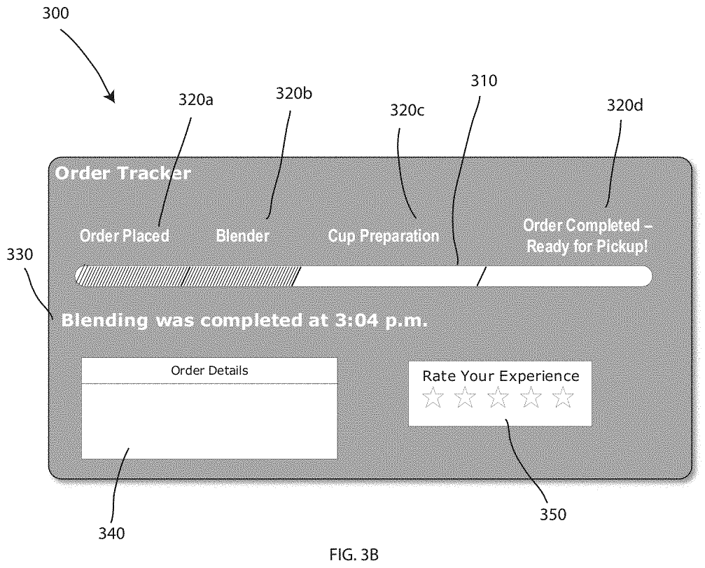

The system for fulfilling orders 100 may further include one or more user devices 116. The user devices 116 may be devices owned and/or operated by an employee or customer of the business embodied by the physical location 110. In the event that the user devices 116 are customer held devices, the user device 116 may be configured to receive notifications or information from the computer system 120 based on the status and/or completion of an order. The user device 116 of a customer may further provide information to the computer system 120 related to the location of the user. For example, in the case that the customer places an order remotely, the user device 116 may be configured to provide information to the computer system 120 that the customer has arrived for pickup. FIGS. 3A and 3B described hereinbelow provide one example of a user interface that might be located on a user device. In the event that the user device 116 is an employee device, the user device 116 may be configured to provide information such as employee location to the computer system for analysis. It should be understood that while one user device 116 is shown in FIG. 1, this schematic representation is representative of a plurality of possible user devices that may be incorporated into the system for fulfilling orders 100 and connectable to the computer system 120 over the network 107.

The network 107 may be any group of two or more computer systems linked together. The network 107 may represent, for example, the internet. The network 107 may be any type of computer network known by individuals skilled in the art. Examples of computer networks which may be embodied by the network 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network 107 may be a peer-to-peer network in some embodiments, wherein in other embodiments, the network 107 may be organized as a client/server architecture.

The network repository 114 may be a data collection area on the network 107 which may back up and save all the data transmitted back and forth between the nodes of the network 107. For example, the network repository 114 may be a data center saving and cataloging user data sent by the user device 116 and/or the work flow system 114, the point of sale order system 113, sensors 112, 115 or the like. The network repository 114 may use this data to generate databases related to the information received. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

The computer system 120 is shown connected to the sensors 112, 115, the user device 116 and the network repository 114 via the network 107. While the computer system 120 is shown as a separate component of the system for fulfilling orders 100 than the physical location 110, in other embodiments, the computer system 120 may be located on-site at the physical location 110 of a business. As shown, the physical location 110 having the sensors 112, 115, etc., may connect to the computer system 120 via the network 107 and the computer system 120 may receive information from the physical location 110 in real time and analyze the information in real time.

Embodiments of the computer system 120 may include a receiving module 131, an analytics module 132, a customer notification module 133, and a task distribution module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines. The modules may each be separate components of the computer system 120. In other embodiments, more than one module may be a single combined computer program, or hardware module.

Embodiments of the receiving module 131 may include one or more components of hardware and/or software program code for obtaining, retrieving, collecting, or otherwise receiving information from the user device 116 and/or the work flow system 114, the point of sale order system 113, sensors 112, 115 or any transmitting device in the order fulfillment system 100. In an exemplary embodiment, the receiving module 131 may be configured to receive information arising from the physical location 110 or the user device 116. In another example, the receiving module 131 may be configured to receive information detected from the sensing devises 112, 115. Further, the receiving module 131 may be configured to receive information directly from the work flow system 114 or the point of sale order system 113. The receiving module 131 may provide information received by the computer system 120 from the user device 116, the work flow system 114, the point of sale order system 113, the sensors 112, 115, etc., to be stored in the data repository 125 or may provide information received directly to the analytics module 132

Referring still to FIG. 1, embodiments of the computer system 120 may further include an analytics module 132. Embodiments of the analytics module 132 may include one or more components of hardware and/or software program code for analyzing information received by the receiving module 131 or stored in the data repository 125. The analytics module 132 may be configured to sense order checkpoint information related to a predetermined checkpoint in each of many orders being processed in parallel from the various sensors 112, 115 of the system for fulfilling orders 100. The analytics module 132 may be configured to analyze this information and detect, identify or determine a sub-optimized workflow from the sensed order checkpoint information. The analytics module 132 may be configured to determine corrections to such a sub-optimized work flow. For example, an order checkpoint may be a time an ingredient is placed into or out of an oven, a coffee begins brewing or completes brewing, or when the entire order begins preparation of completes preparation. The sensors 112, 115 in the system 100 may detect the state of an order at these predetermined checkpoints automatically, send this information to the computer system 120, and the analytics module 132 may be configured to automatically detect sub-optimized workflows. For example, the analytics module 132 may be configured to determine that more employees are needed preparing ordered items and less taking orders. The analytics module 132 may determine that more employees are needed at one particular point in the workflow, and less are needed elsewhere. Still further, the analytics module 132 may be configured to determine that more preparation devices are needed to fulfill regular demand based on an analysis over time.

The analytics module 132 may be configured to, for example, generate a workflow that optimizes completion of a plurality of orders by generating a set of modified tasks. This may occur after the analytics module 132 detects a sub-optimized workflow, for example, as described above. In one example, the analytics module 132 may receive information from the motion sensing system 115, the point of sale order system 113 and the sensor 112 of the order preparation device 111 and determine that a first order should be delayed while a second order should be prioritized in the event that the first order requires the user of a preparation device 111 that is in use while the second order requires devices which are available. In other embodiment, the analytics module 132 may be configured identify or determine a more efficient modified task order for either or both of employees and/or order preparation devices, which may be automated. For example, the analytics module 132 may be configured to identify from an order placed at the point of sale order system 113 will require the oven be turned on and pre-heated. The analytics module 132 may be configured to identify from the sensor 112 of the order preparation device 111 that the order preparation device 111 should perform a self-cleaning routine because the order preparation device 111 is not going to be needed in near-future orders. Further, the analytics module 132 may be configured to determine over an analysis occurring over a period of time, that the physical location 110 would benefit from one or more additional order preparation devices 111 to prevent recurring backlogs.

Still further, the analytics module 132 may be configured to use the movement information provided by the motion sensing information 115 to generate the workflow of employees and/or order preparation devices 111. The analytics module 132 may be configured to associate locations in the physical location 110 to tasks performed. For example, the analytics module 132 may understand that an employee located at a first preparation station is conducting work assigned to the first preparation station. The analytics module 132 may take the understanding of the physical location 110 layout and employee position within the layout, and use this information to make determinations as to re-assign employees, or determine suggestions related to the re-assignment of employees, to different stations to optimize the work flow. The analytics module 132 may utilize sensed information from the sensors 112, 115 in conjunction with the motion sensing system 115 to make determinations of where work flow and/or employee reassignments may be desirable. The analytics module 132 may be configured to identify or determine from the motion sensing system 115 restocking situations are imminent and may initiate the process for notifying employees of such situations.

The analytics module 132 may further be configured to determine, from information sensed by the sensors 112, 115 or the like, that steps are completed in the preparation process of an item purchased by a patron or customer. For example, the analytics module 132 may determine that a coffee has been poured into a cup by a single-use sensor located in the cup. The analytics module 132 may determine that preparation of an item is completed and ready for pick-up or delivery by a customer or patron. The analytics module 132 may determine that preparation has begun on an item. Various steps of the process from beginning to fulfill an order, to completion, may be determined from the sensed information provided to the analytics module 132. The analytics module 132 may further be configured to estimate a time of completion of a given order based on automatically sensed information from the sensors 112, 115, and the initial time the order was placed at the point of sale order system 113.

Embodiments of the customer notification module 133 may include one or more components of hardware and/or software program code for notifying customers regarding the fulfillment of orders. For example, the customer notification module 133 may be configured to receive information or a determination from the analytics module 132 and convert that determination into the appropriate customer notification. The customer notification module 133 may be configured to provide a push notification to a customer. Alternatively, the customer notification module 133 may be configured to provide a notification via a user interface through an application, website, or the like. The customer notification module 133 may be configured to notify a customer that a step of the process of fulfilling an order is completed. The customer notification module 133 may be configured to notify a customer that the process of fulfilling an order has begun. The customer notification module 133 may be configured to notify a customer that the process of fulfilling an order is completed in its entirety.

The customer notification module 133 may be configured to provide a digital notification to the customer that includes an updated time of completion of the order. Further, this may be based on, at least in part, the time the customer entered the order and an estimated time of completion of at least a portion of the set of modified tasks. For example, if the analytics module 132 determines, from automatically sensed information, that the estimated time of completion is 30 minutes, the customer notification module 133 may provide this estimation to the customer.

With continued reference to FIG. 1, embodiments of the computer system 120 may include a task distribution module 134. Embodiments of the task distribution module 134 may include one or more components of hardware and/or software program code for providing a set of modified tasks from the computer system 120 to a system controlled by the business, such as the work flow system 114, or an order preparation device 111, or a user device 116 operated by an employee. For example the task distribution module 134 may be configured to provide at least a portion of modified tasks to employees, either via the work flow system 114 or the employee user device 116. The task distribution module 134 may be configured to provide at least a portion of modified tasks to at least one automated order preparation device 111. In one embodiment, the task distribution module 134 may provide a control signal to the order preparation device 111 to perform a task based on the modified task determined by the analytics module 132. The task distribution module 134 may be configured to provide updated tasks to both employees or devices based on automatically gathered, received, and analyzed information sensed by the sensors of the system and provided to the computer system 120. The task distribution module may be configured to send updated tasks to generate optimized workflow when sub-optimized workflow patterns are detected by the analytics module 132.

Referring still to FIG. 1, embodiments of the computer system 120 may be equipped with a memory device 142 which may store the information related to the data center 110 and/or the battery system 111 thereof. The computer system 120 may further be equipped with a processor 141 for implementing the tasks associated with the system for fulfilling orders 100.

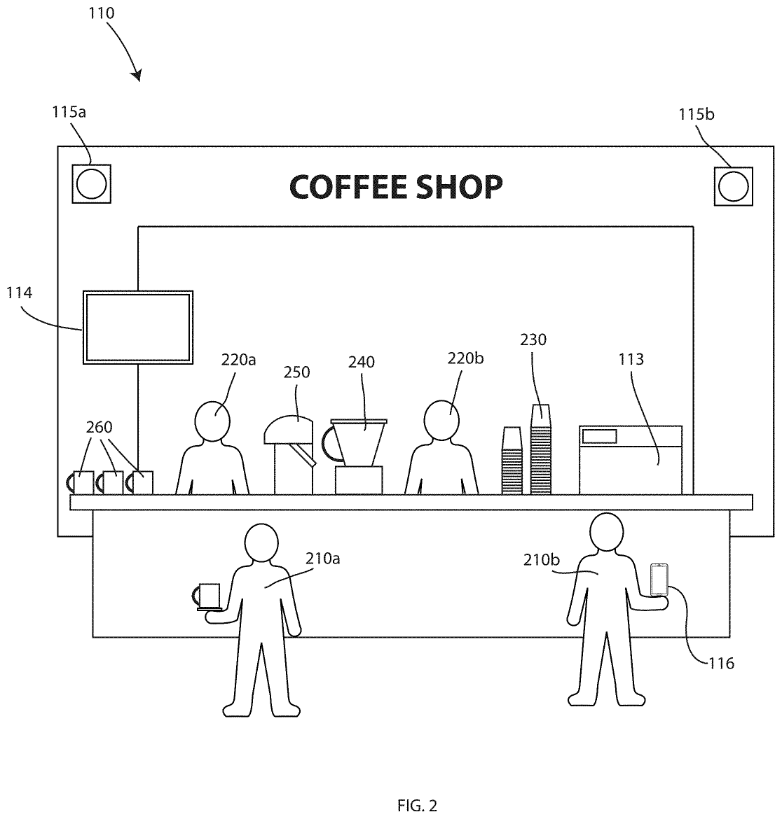

FIG. 2 depicts a perspective view of an exemplary embodiment of the physical location 110 of the system of FIG. 1, in accordance with embodiments of the present invention. The physical location 110 is shown as a coffee shop that includes the point of sale ordering system 113 which comprises a cash register and order input computer system. The work flow system 114 is shown embodied by a computer display which is visible by employees which may display workflow information to the employees to help direct workflow. The motion sensing system 115 is shown as two video recording devices 115a, 115b located in the corner of the coffee shop. Two customers 210a, 210b are shown in the embodiment. One customer is holding a delivered item that has already been completed. Another customer is holding the user device 116 which may be receiving information related to a placed order from the computer system 120. Employees 220a, 220b are shown. Various order preparation devices are shown including mugs 260, cups 230, a beverage storage container 250 and a blender 240. Each of these devices may include one or more sensors 112 (not shown) for detecting the state of these devices as described herein.

FIG. 3A depicts a notification interface 300 of the system for fulfilling orders of FIG. 1 at a first stage in a workflow, in accordance with embodiments of the present invention. The notification interface 300 includes an order tracking bar 310 that is broken into various stages: an “order placed” stage 320a, a “blender” stage 320b, a “cup preparation” stage 320c, and an “order completed, ready for pickup!” stage 320d. This notification interface 300 may correspond to a workflow for fulfilling an order of a blended drink. The notification interface 300 includes an order details 340 section, which may display the order details to a customer so that the customer can confirm that the order was placed properly and provided into the work flow system 114 properly. The notification interface 300 may further include an experience rating interface 350. This shows that the notification interface 300 may be a two way communication interface for allowing the customer to communicate with the computer system 120 and allowing the computer system 120 to further provide information to the customer. In FIG. 3B, the order tracker bar 310 displays that progress in fulfilling the order has only reached the order placement stage at 2:59 P.M. This is provided in a text status portion 330 of the user interface. It should be understood that the notification interface 300 may further include various other features not shown, such as for example, an estimated time of completion.

FIG. 3B depicts the notification interface 300 of FIG. 3A at a second stage in the workflow, in accordance with embodiments of the present invention. At this stage, the order tracker bar 310 displays that the blending was completed. Thus, the text status portion 330 provides a text message that the blending was completed at 3:04 P.M. In this embodiment, the order preparation device 111 may be the blender 240. The blender 240 may include order preparation sensors which may automatically provide information to the computer system 120 when the blending for an order is started and/or completed. When completed, the computer system 120 may automatically provide a notification to the user. The blender 240 may have automatically been activated by the computer system 120 upon placement of the order. It should be understood that this is one example of an interface for providing information to a user that is automatically sensed and automatically cognitively analyzed by the computer system 120.

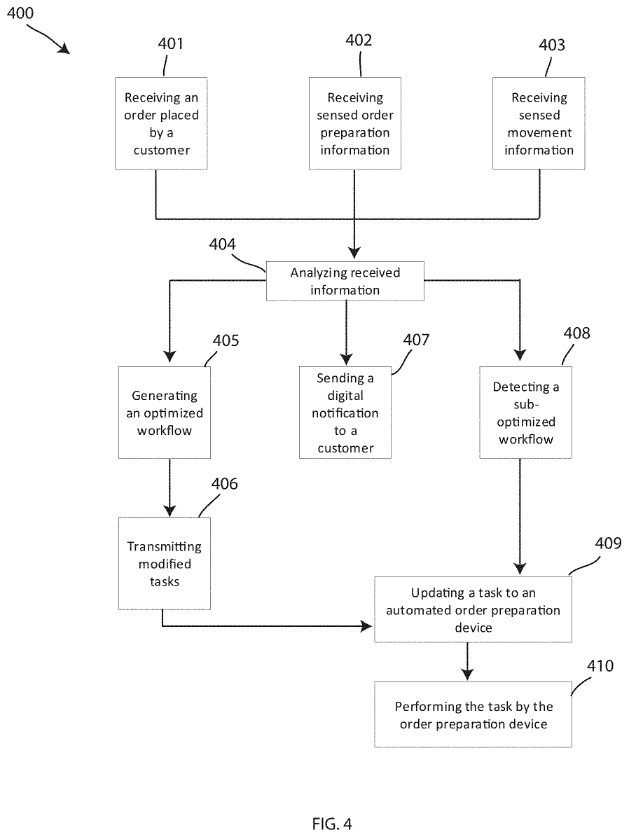

FIG. 4 depicts a flow chart of a method 400 for fulfilling orders, in accordance with embodiments of the present invention. The method 400 may include initial steps of receiving various information. For example, a step 401 may include receiving, by one or more processors of a computer system such as the computer system 120, an order placed by a customer, such as the customer 210a or 210b. The method 400 may include identifying an order placed by the customer that includes preparation of at least one item included in the order at a physical location. The method 400 may include a step 402 receiving sensed order preparation information from, for example, at least one sensor, such as one of the sensors 112, 115, at a physical location such as the physical location 110. The method 400 may include a step 403 of receiving, by the one or more processors of the computer system, movement information detected by at least one sensor at the physical location, such as the movement sensing system 115, the movement information related to movement of both customers and employees within the physical location. The method 400 may include a step 404 of analyzing any of the received information received by the computer system, by for example, the analytics module 132. The method 400 may include a step 407 of sending or otherwise providing a digital notification to the customer that includes information such as the status of an order or an updated time of completion of the order. The method 400 may include a step 405 of generating, by the one or more processors of the computer system, a workflow that optimizes completion of a plurality of orders including the order made by the customer, by generating a set of modified tasks for employees and at least one automated order preparation device based at least in part on the received sensed order preparation information. The method 400 may include a step 406 of providing or otherwise transmitting modified tasks to the employees and to at least one automated order preparation device. The method 400 may include a step 408 of detecting, by the one or more processors of the computer system, a sub-optimized workflow from the sensed order checkpoint information. The method 400 may include a step 409 of updating, by an automated order preparation device, a task to the automated order preparation device and a step 410 of performing the task by the order preparation device 410. Steps 409 and 410 may be conducted in response to the detecting a suboptimized work flow in step 408 and/or in response to the transmitting the modified tasks in step 406 by the computer system.

Methods contemplated herein may further include detecting detecting, by the at least one sensor in the physical location, the movement information related to the movement of both customers and employees within the physical location. Still further methods may include detecting, by the at least one sensor in the physical location, the sensed order preparation information related to the order, and providing, by the at least one sensor in the physical location, the sensed order preparation information and the movement information to the one or more processors of the computer system.

Methods may include receiving, by the at least one automated order preparation device, the sent at least the portion of the set of modified tasks. Methods may include performing, by the at least one automated order preparation device, a task directed by the sent at least the portion of the set of modified task.

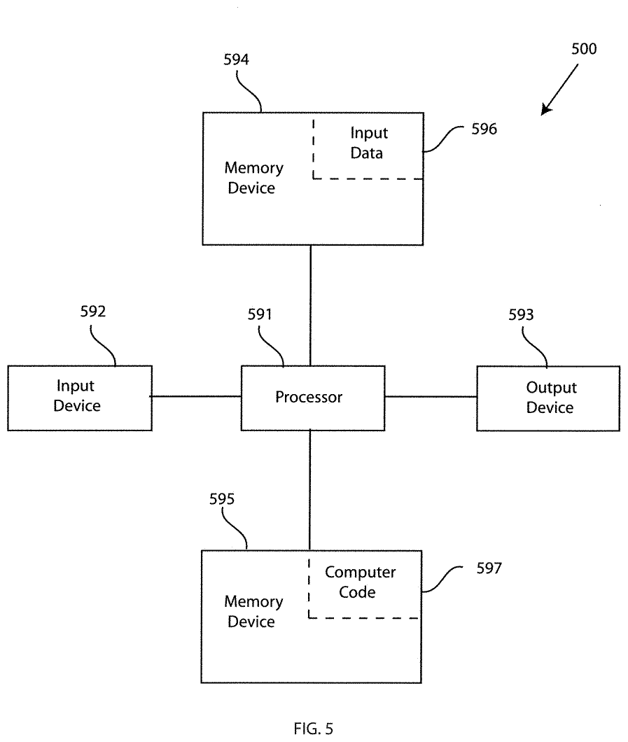

FIG. 5 illustrates a block diagram of a computer system that may representative of any computer or computer system within the system for fulfilling orders of FIGS. 1-2, capable of implementing methods for fulfilling orders of FIG. 4, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for fulfilling orders, in the manner prescribed by the embodiments of FIG. 4 using the system for fulfilling orders of FIGS. 1-2, wherein the instructions of the computer code 597 may be executed by processor 591 via memory device 595. The computer code 597 may include software or program instructions that may implement one or more algorithms for implementing the methods of fulfilling orders, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 5.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for fulfilling orders. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide a system for fulfilling orders. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for fulfilling orders. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for fulfilling orders.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

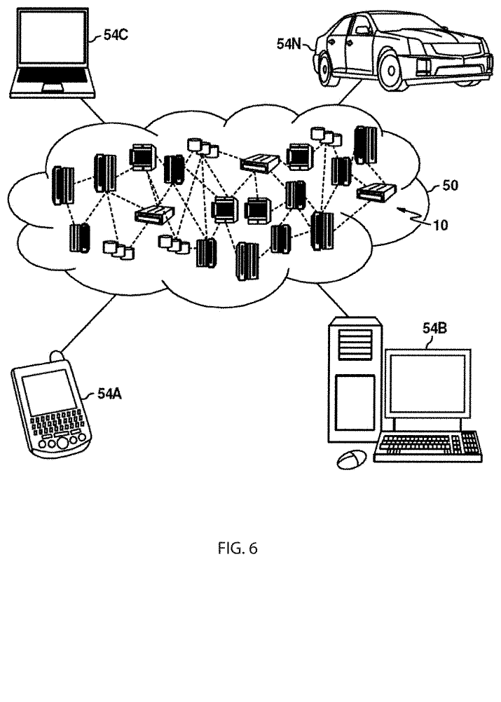

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 6 are intended to be illustrative only and that computing nodes 10 and cloud computing environment 50 can communicate with any type of computerized device over any type of network and/or network addressable connection (e.g., using a web browser).

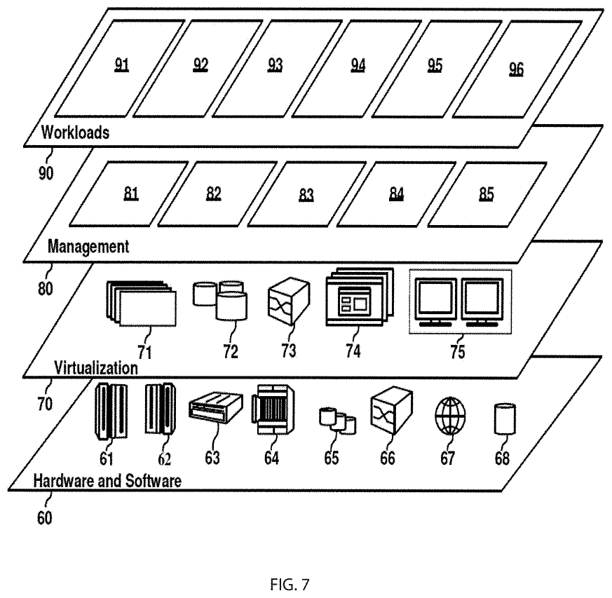

Referring now to FIG. 7, a set of functional abstraction layers provided by cloud computing environment 50 (see FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing of order fulfillment 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of order identification from sensors, the method comprising:
identifying, by one or more processors of a computer system, an order placed by a customer that includes preparation of at least one item included in the order at a physical location;
receiving, by the one or more processors of the computer system, sensed order preparation information from at least one sensor at the physical location, the sensed order preparation information related to the order;
generating, by the one or more processors of the computer system, a workflow that optimizes completion of a plurality of orders including the order by generating a set of modified tasks for employees and at least one automated order preparation device based at least in part on the received sensed order preparation information; and
providing, by the one or more processors of the computer system, at least a portion of the set of modified tasks to the employees and to the at least one automated order preparation device.

2. The method of claim 1, further comprising providing a digital notification to the customer that includes an updated time of completion of the order.

3. The method of claim 2, wherein the providing is based, at least in part, on the time the customer entered the order and an estimated time of completion of at least a portion of the set of modified tasks.

4. The method of claim 1, further comprising:
receiving, by the one or more processors of the computer system, movement information detected by at least one sensor at the physical location, the movement information related to movement of both customers and employees within the physical location; and
using, by the one or more processors of the computer system, the movement information in the generating the workflow.

5. The method of claim 4, further comprising:
detecting, by the at least one sensor in the physical location, the movement information related to the movement of both customers and employees within the physical location;
detecting, by the at least one sensor in the physical location, the sensed order preparation information related to the order; and
providing, by the at least one sensor in the physical location, the sensed order preparation information and the movement information to the one or more processors of the computer system.

6. The method of claim 1, further comprising:
receiving, by the one or more processors of the computer system, sensed order checkpoint information related to a predetermined checkpoint in each of the plurality of orders occurring in parallel from the at least one sensor at the physical location;
analyzing, by the one or more processors of the computer system, the sensed order checkpoint information; and
detecting, by the one or more processors of the computer system, a sub-optimized workflow from the sensed order checkpoint information.

7. The method of claim 1, further comprising:
receiving, by the at least one automated order preparation device, the sent at least the portion of the set of modified tasks; and
performing, by the at least one automated order preparation device, a task directed by the sent at least the portion of the set of modified task.

8. A computer system, comprising:
one or more processors;
one or more memory devices coupled to the one or more processors; and
one or more computer readable storage devices coupled to the one or more processors, wherein the one or more storage devices contain program code executable by the one or more processors via the one or more memory devices to implement a method of fulfilling orders, the method comprising:
identifying, by the one or more processors of the computer system, an order placed by a customer that includes preparation of at least one item included in the order at a physical location;
receiving, by the one or more processors of the computer system, sensed order preparation information from at least one sensor at the physical location, the sensed order preparation information related to the order;
generating, by the one or more processors of the computer system, a workflow that optimizes completion of a plurality of orders including the order by generating a set of modified tasks for employees and at least one automated order preparation device based at least in part on the received sensed order preparation information; and
providing, by the one or more processors of the computer system, at least a portion of the set of modified tasks to the employees and to the at least one automated order preparation device.

9. The computer system of claim 8, the method further comprising:
providing a digital notification to the customer that includes an updated time of completion of the order.

10. The computer system of claim 9, wherein the providing is based, at least in part, on the time the customer entered the order and an estimated time of completion of at least a portion of the set of modified tasks.

11. The computer system of claim 8, the method further comprising:
receiving, by the one or more processors of the computer system, movement information detected by at least one sensor at the physical location, the movement information related to movement of both customers and employees within the physical location; and
using, by the one or more processors of the computer system, the movement information in the generating the workflow.

12. The computer system of claim 11, the method further comprising:
detecting, by the at least one sensor in the physical location, the movement information related to the movement of both customers and employees within the physical location;
detecting, by the at least one sensor in the physical location, the sensed order preparation information related to the order; and
providing, by the at least one sensor in the physical location, the sensed order preparation information and the movement information to the one or more processors of the computer system.

13. The computer system of claim 8, the method further comprising:
receiving, by the one or more processors of the computer system, sensed order checkpoint information related to a predetermined checkpoint in each of the plurality of orders occurring in parallel from the at least one sensor at the physical location;
analyzing, by the one or more processors of the computer system, the sensed order checkpoint information; and
detecting, by the one or more processors of the computer system, a sub-optimized workflow from the sensed order checkpoint information.

14. The computer system of claim 8, the method further comprising:
receiving, by the at least one automated order preparation device, the sent at least the portion of the set of modified tasks; and
performing, by the at least one automated order preparation device, a task directed by the sent at least the portion of the set of modified task.

15. A computer program product, comprising a computer readable hardware storage device storing a computer readable program code, the computer readable program code comprising an algorithm that when executed by one or more processors of a computer system implements a method of fulfilling orders, the method comprising:
identifying, by the one or more processors of the computer system, an order placed by a customer that includes preparation of at least one item included in the order at a physical location;
receiving, by the one or more processors of the computer system, sensed order preparation information from at least one sensor at the physical location, the sensed order preparation information related to the order;
generating, by the one or more processors of the computer system, a workflow that optimizes completion of a plurality of orders including the order by generating a set of modified tasks for employees and at least one automated order preparation device based at least in part on the received sensed order preparation information; and
providing, by the one or more processors of the computer system, at least a portion of the set of modified tasks to the employees and to the at least one automated order preparation device.

16. The computer program product of claim 15, the method further comprising:
providing a digital notification to the customer that includes an updated time of completion of the order.

17. The computer program product of claim 16, wherein the providing is based, at least in part, on the time the customer entered the order and an estimated time of completion of at least a portion of the set of modified tasks.

18. The computer program product of claim 15, the method further comprising:
receiving, by the one or more processors of the computer system, movement information detected by at least one sensor at the physical location, the movement information related to movement of both customers and employees within the physical location; and
using, by the one or more processors of the computer system, the movement information in the generating the workflow.

19. The computer program product of claim 18, the method further comprising:
detecting, by the at least one sensor in the physical location, the movement information related to the movement of both customers and employees within the physical location;
detecting, by the at least one sensor in the physical location, the sensed order preparation information related to the order; and
providing, by the at least one sensor in the physical location, the sensed order preparation information and the movement information to the one or more processors of the computer system.

20. The computer program product of claim 15, the method further comprising:
receiving, by the one or more processors of the computer system, sensed order checkpoint information related to a predetermined checkpoint in each of the plurality of orders occurring in parallel from the at least one sensor at the physical location;
analyzing, by the one or more processors of the computer system, the sensed order checkpoint information; and
detecting, by the one or more processors of the computer system, a sub-optimized workflow from the sensed order checkpoint information.
